(19) United States
(12) Patent Application Publication
(10) Pub. No.: US 2010/0215065 A1
(43) Pub. Date: Aug. 26, 2010

(54) Coherent multiple-stage optical rectification terahertz wave generator

(75) Inventors: Ci-Ling Pan, Hsinchu (TW); Jung Y. Huang, Hsinchu (TW); Chen-Shiung Chang, Hsinchu (TW); Ching-Wei Chen, Taichung County (TW); Yu-Shian Lin, Hsinchu (TW); Li Yan, Guangzhou (CN); Chao-Kuei Lee, Kaohsiung (TW)

Correspondence Address: BACON & THOMAS, PLLC, 625 SLATERS LANE, FOURTH FLOOR, ALEXANDRIA, VA, 22314-1176, US

(73) Assignee: National Chiao Tung University, Hsinchu (TW)

(21) Appl. No.: 12/585,224

(22) Filed: Sep. 9, 2009

(30) Foreign Application Priority Data
Feb. 25, 2009 (TW) 098105905

(51) Int. Cl. H01S 3/10

(52) U.S. Cl. 372/21; 250/493.1

(57) ABSTRACT

The present invention coherent multiple-stage optical rectification terahertz wave generator discloses the generation of single-cycle terahertz radiation with two-stage optical rectification in GaSe crystals. By adjusting the time delay between the pump pulses employed to excite the two stages, the terahertz radiation from the second GaSe crystal can constructively superpose with the seeding terahertz field from the first stage. The high mutual coherence between the two terahertz radiation fields is ensured with the coherent optical rectification process and can be further used to synthesize a desired spectral profile of output coherent THz radiation. The technique is also useful for generating high amplitude single-cycle terahertz pulses, not limited by the pulse walk-off effect from group velocity mismatch in the nonlinear optical crystal used.

### BACKGROUND OF THE INVENTION

1. Field of the Invention

The present invention relates to a terahertz wave generator, particularly to a coherent multiple-stage optical rectification terahertz wave generator.

2. Description of the Prior Art

The terahertz (THz) wave is an electromagnetic wave and the frequency is around 10¹² hertz (Hz). It includes the electromagnetic wave lain between millimeter-wave (˜0.1 THz) and far-infrared region (˜25 THz). Due to the unique and excellent characteristics, it is already used for material analysis and various tests in the other fields at present. However, it still cannot effectively cover the required frequency with sufficient power, tunability and stability; it is not an economic light source and component. Thus, the practical application of terahertz wave is still limited.

Among the conventional prior literature, such as “Nonlinear cross-phase modulation with intense single-cycle terahertz pulses, Physics Review Letter 99, 043901 (2007)”, the accelerator was employed to produce the synchronous radiation and the nonlinear optical crystal was introduced to release the terahertz wave. However, it is difficult to obtain the accelerator, it is very inconvenient to obtain the terahertz radiation source for the convenient application.

Among the conventional prior literature, such as “Generation of 1.5 μJ single-cycle terahertz pulses by optical rectification from a large aperture ZnTe crystal, Optics Express 15, 13212-13220 (2007)”, a large-area nonlinear optical crystal and ultrafast laser source were employed to generate terahertz radiation. However, the fabrication process of crystal is quite difficultly achieved and the fabrication cost is very high, the practical application of terahertz wave is very inconvenient; also, the application is limited.

Among the other conventional prior literatures, such as “Cascaded nonlinear difference-frequency generation of enhanced terahertz wave production, Opt. Letter 29, 2046-2048 (2004)” and “Simulation study on cascaded terahertz pulse generation in electro-optic crystals, Optics Express 15, 8076-8093 (2007)”, the difference-frequency and the optical rectification principles were used to simulate the generation of terahertz wave. However, these two literatures did not disclose any actual technique. These two literatures could only verify that the enhanced terahertz wave might be produced theoretically, but it was still unable to be enabled in accordance with the description. Thus, in the practical application, except it was unable to be enabled in the actual field, the possibility of industrial utilization was even lacked.

In addition, among the other conventional prior literatures, such as “Generation and spectral manipulation of coherent terahertz radiation with two-stage optical rectification, Optics Express 16, 14294-14303 (2008)”, the multiple-stage optical rectification technique was used to generate the enhanced terahertz wave with characteristics of broadband and coherent terahertz radiation sources. It was still the theoretical idea for the coherent multiple-stage optical rectification terahertz wave generator.

Therefore, in order to generate more efficient terahertz radiation sources, it is necessary to research and develop new terahertz wave generation technique, and then to raise the efficiency of radiation sources and reduce the manufacturing time and manufacturing cost.

### SUMMARY OF THE INVENTION

The coherent multiple-stage optical rectification terahertz wave generator of the present invention possesses high power of terahertz wave and high coherence of broadband terahertz radiation sources, which can provide the terahertz wave in various application fields.

The present invention proposes a multiple-stage optical rectification technique, which generate the coherent terahertz radiation sources in the nonlinear gallium selenide (GaSe) optical crystal. By adjusting the time delay between the pump pulses employed to excite the two stages, the terahertz radiation from the second GaSe can constructively superpose with the seeding terahertz field from the first stage. Thus it can be applied to the spectral manipulation technique of terahertz radiation.

The coherent multiple-stage optical rectification terahertz wave generator of the present invention comprises a terahertz time domain spectroscopy (THz-TDS), which provides the ultrafast laser pulse, and the multiple-stage superposition system, which can generate nonlinear optical rectification process and has the function of extension and expansion.

The optical rectification technique of the present invention can overcome the length of crystal and restriction of group velocity mismatch, which also has the potential for developing the output of enhanced terahertz radiation sources.

The coherent multiple-stage optical rectification terahertz wave generator of the present invention is a terahertz wave technique with actual application, which can provide the enhanced coherent terahertz radiation sources.

The present invention employs the multiple-stage superposition technique to generate the intense terahertz wave, which can provide the excellent broadband and coherent terahertz radiation sources.

The present invention can overcome the restriction of crystal process, and it can be formed by simple optical components only. It is simple and easy to be operated with the advantages of extension and expansion, thus the usage is very convenient.

The present invention can be used in widely applications in optical component, optical measurement, biomedical inspection, medical image, spectroscopy, radar, communication, encapsulation inspection and other related fields.

The advantage and spirit of the invention can be understood further by the following detail description of invention and attached figures.

### BRIEF DESCRIPTION OF THE DRAWINGS

The foregoing aspects and many of the attendant advantages of this invention will become more readily appreciated as well becomes better understood by reference to the following detailed description, when taken in conjunction with the accompanying drawings, wherein:

FIG. 1 shows the coherent multiple-stage optical rectification terahertz wave generator of the present invention.

FIG. 2 shows the schematic diagram of the multiple-stage superposition principle of the present invention.

FIG. 3A shows the comparison of the injecting terahertz waveform and the superposed waveform of the two terahertz fields.

FIG. 3B shows the coherence degree of the present invention.

### DESCRIPTION OF THE PREFERRED EMBODIMENT

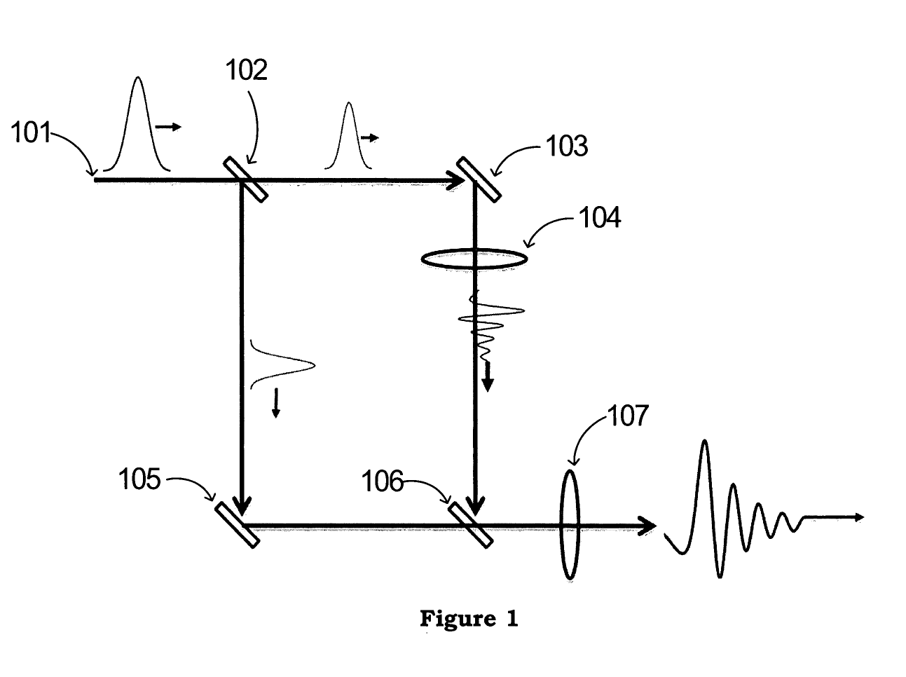

Please refer to FIG. 1, which shows the schematic diagram of the coherent multiple-stage optical rectification terahertz wave generator of the present invention. The detailed description is described as follows:

Firstly, as shown in FIG. 1, ultrafast laser pulse 101 is introduced to first beam splitter 102. Next, ultrafast laser pulse 101 can pass through first nonlinear optical crystal (GaSe) 104 via first reflective mirror 103. Then the generated terahertz wave will be introduced to the second nonlinear optical crystal 107 via terahertz wave reflective mirror 106. This is called as the nonlinear optical rectification process, which generates the first broadband terahertz wave, namely the first terahertz radiation produced from the first stage.

Then, still as shown in FIG. 1, ultrafast laser pulse 101 is introduced to first beam splitter 102. Ultrafast laser pulse 101 can pass through second nonlinear optical crystal 107 via second reflective mirror 105. The nonlinear optical rectification process is used to generate the second broadband terahertz wave, which is constructively superposed to that from the first stage. The time delay between the first broadband terahertz wave and the second broadband terahertz wave is adjusted precisely, so that both terahertz waves can be superposed totally in the time domain.

Then, still as shown in FIG. 1, the coherent multiple-stage optical rectification terahertz wave generator of the present invention comprises the followings:

A THz-TDS can provide and control the generation of THz source via the second-order and via third-order nonlinear equation.

A multiple-stage superposition system includes a plurality of reflective mirrors, a plurality of beam splitters, and a plurality of nonlinear optical crystals. The system can produce a plurality of nonlinear optical rectification processes and has the function of extension and expansion. Among the system, the indium-tin-oxide (ITO) glass plate is used as the terahertz wave reflective mirror, which is used as the collinear combining device of ultrafast laser and terahertz wave to reduce the loss.

The high power and high coherent terahertz wave of the present invention can be superposed by the cascaded terahertz radiation sources, in order to generate the intense terahertz wave. Especially, the ultrafast laser source is associated with the terahertz time domain spectroscopy (THz-TDS) to provide the THz wave.

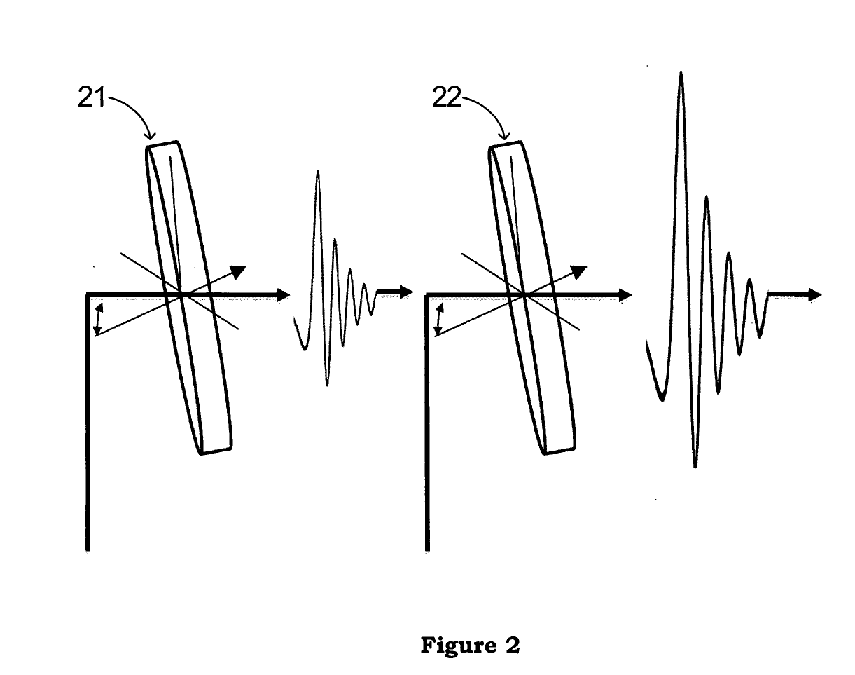

FIG. 2 shows the schematic diagram of the multiple-stage superposition principle of the present invention. The output of enhanced terahertz wave can be obtained by superposing the first terahertz radiation (terahertz wave) generated from the first nonlinear crystal 21 via the first-stage optical rectification and the second terahertz radiation (terahertz wave) generated from the second nonlinear crystal 22 via the second-stage optical rectification. Thus, the mathematical equation of the present invention can be shown as the follows:

$$\begin{matrix}{E}_{total} = {\sum }_{ω = 0}^{∞} E ( ω ) \\ E ( ω ) = {E}_{1} ( ω ) + {E}_{2} ( ω ) {e}^{- j ω τ}\end{matrix}$$

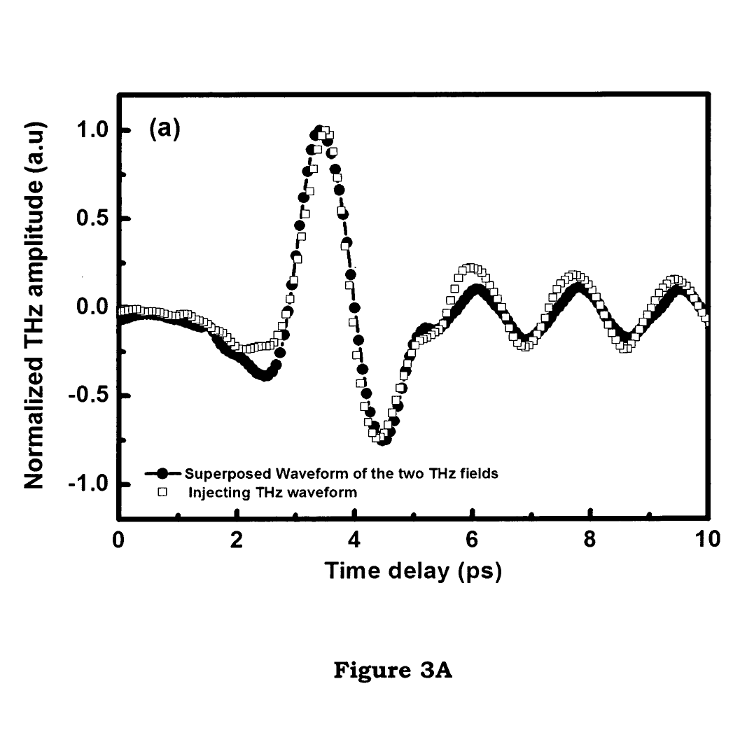

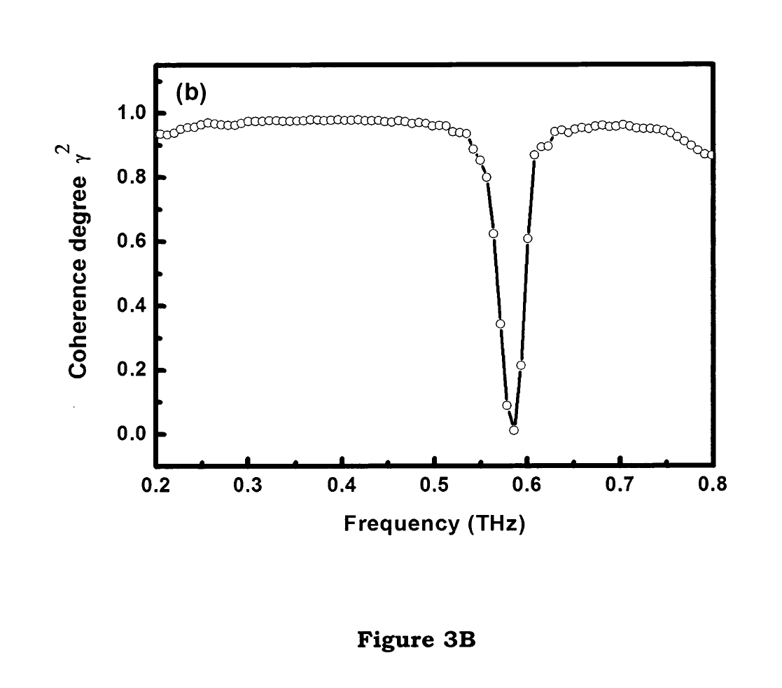

FIG. 3A shows the comparison of the injecting terahertz waveform and the superposed waveform of the two terahertz fields. It is shown that the waveform is very similar between the injecting terahertz wave and the superposed terahertz wave. If the coherence of both terahertz waves is analyzed, more substantial description is shown as the follows:

Theoretically, when two electromagnetic waves are approaching to produce the interference, the coherence degree can be described by the following mathematical equation:

$$\begin{matrix}{γ}_{12}^{2} = \frac{{\vert {S}_{12} ( f ) \vert}^{2}}{{\vert {S}_{11} ( f ) \vert}^{2} {\vert {S}_{22} ( f ) \vert}^{2}} & \\ {S}_{ij} = {\int }_{- ∞}^{∞} {R}_{ij} ( τ ) {e}^{- j2 π f τ} d τ & i , j = 1 , 2 \\ {R}_{ij} ( τ ) = {\int }_{- ∞}^{∞} {E}_{i} ( t ) {E}_{j} ( t + τ ) d τ & i , j = 1 , 2\end{matrix}$$

where E denotes the measured terahertz wave, τ denotes the time delay between the two waves, R denotes the correlation function between the two waves, S denotes the correlation function of Fourier space, and γ² denotes the coherence degree between the two waves.

If the electromagnetic waves are pulses, the shift platform can be used to adjust the time delay, so that they can be superposed totally. By adjusting the time delay between the two waves, the superposition and coherence degree of the two electromagnetic waves can be maximized.

FIG. 3B shows the coherence degree of the present invention. The terahertz wave has broad frequency range and very high coherence property. In this experiment, the terahertz radiation source with high power and high coherence degree can be obtained by only adjusting the time delay without altering other optical components.

In a preferred embodiment of the present invention, though the GaSe nonlinear optical crystal with negative optical axis is used as the crystal to generate the terahertz wave, other nonlinear optical crystals can also be used, such as zinc telluride (ZnTe), lithium niobate (LiNbO₃) and gallium phosphide (GaP) etc. or other optical crystals with low absorption coefficient at terahertz spectral range. The second-order nonlinear process can be used to generate the terahertz wave, or the third-order nonlinear way such as high excitation plasma can be used as the terahertz radiation sources.

In the present invention, the generation of intense terahertz wave is not limited to two-stage superposition, the multiple-stage structure can be expanded in accordance with the space and intensity of terahertz wave.

It is understood that various other modifications will be apparent to and can be readily made by those skilled in the art without departing from the scope and spirit of this invention. Accordingly, it is not intended that the scope of the claims appended hereto be limited to the description as set forth herein, but rather that the claims be construed as encompassing all the features of patentable novelty that reside in the present invention, including all features that would be treated as equivalents thereof by those skilled in the art to which this invention pertains.

What is claimed is:

1. A coherent multiple-stage optical rectification terahertz wave generator, comprising:
a laser source, the laser source providing an ultrafast laser pulse; and
a multiple-stage superposition system, the multiple-stage superposition system producing a plurality of nonlinear optical rectification processes in order to generate and superpose a plurality of broadband terahertz waves to form the coherent multiple-stage optical rectification terahertz wave generator.

2. The apparatus according to claim 1, wherein the laser source comprises a terahertz time domain spectroscopy (THz-TDS).

3. The apparatus according to claim 2, wherein the terahertz time domain spectroscopy comprises a second-order nonlinear process to produce and control the laser source.

4. The apparatus according to claim 2, wherein the terahertz time domain spectroscopy comprises a third-order nonlinear process to produce and control the laser source.

5. The apparatus according to claim 4, wherein the third-order nonlinear process comprises a high excitation plasma for producing the laser source.

6. The apparatus according to claim 1, wherein the multiple-stage superposition system comprises a plurality of reflective mirrors, a plurality of beam splitters, and a plurality of nonlinear optical crystals.

7. The apparatus according to claim 6, wherein the nonlinear optical crystal comprises a gallium selenide (GaSe).

8. The apparatus according to claim 6, wherein the nonlinear optical crystal comprises a zinc telluride (ZnTe).

9. The apparatus according to claim 6, wherein the nonlinear optical crystal comprises a lithium niobate (LiNbO₃).

10. The apparatus according to claim 6, wherein the nonlinear optical crystal comprises a gallium phosphide (GaP).

11. A coherent multiple-stage optical rectification terahertz wave generator, comprising:
a terahertz time domain spectroscopy, the terahertz time domain spectroscopy providing an ultrafast laser pulse as a laser source; and
a multiple-stage superposition system, the multiple-stage superposition system having a plurality of reflective mirrors, a plurality of beam splitters, and a plurality of nonlinear optical crystals, the multiple-stage superposition system producing a plurality of nonlinear optical rectification processes and having a function of extension and expansion in order to form the coherent multiple-stage optical rectification terahertz wave generator.

12. The apparatus according to claim 11, wherein the terahertz time domain spectroscopy comprises a second-order nonlinear process to control and generate the THz source.

13. The apparatus according to claim 11, wherein the terahertz time domain spectroscopy comprises a third-order nonlinear process to control and generate the THz source.

14. The apparatus according to claim 13, wherein the third-order nonlinear process comprises a high excitation plasma to generate the THz source.

15. The apparatus according to claim 11, wherein the nonlinear optical crystal comprises a gallium selenide (GaSe).

16. The apparatus according to claim 11, wherein the nonlinear optical crystal comprises a zinc telluride (ZnTe).

17. The apparatus according to claim 11, wherein the nonlinear optical crystal comprises a lithium niobate (LiNbO₃).

18. The apparatus according to claim 11, wherein the nonlinear optical crystal comprises a gallium phosphide (GaP).

19. A method for generating the coherent multiple-stage optical rectification terahertz wave, comprising:
providing an ultrafast laser source and a multiple-stage superposition system to generate a plurality of broadband terahertz waves; and
superposing a plurality of broadband terahertz waves, adjusting a time delay between the plurality of broadband terahertz waves, so that a plurality of broadband terahertz waves is superposed totally in a time domain in order to form the coherent multiple-stage optical rectification terahertz wave.

20. The method according to claim 19, wherein the ultrafast laser source comprises the ultrafast laser source being associated with a terahertz time domain spectroscopy (THz-TDS) to provide the THz wave.

21. The method according to claim 20, wherein the terahertz time domain spectroscopy comprises a second-order nonlinear process to produce and control the laser source.

22. The method according to claim 20, wherein the terahertz time domain spectroscopy comprises a third-order nonlinear process to produce and control the laser source.

23. The method according to claim 22, wherein the third-order nonlinear process comprises a high excitation plasma for producing the laser source.

24. The method according to claim 19, wherein the multiple-stage superposition system comprises a plurality of reflective mirrors, a plurality of beam splitters, and a plurality of nonlinear optical crystals.

25. The method according to claim 19, wherein the nonlinear optical crystal comprises a gallium selenide (GaSe).

26. The method according to claim 19, wherein the nonlinear optical crystal comprises a zinc telluride (ZnTe).

27. The method according to claim 19, wherein the nonlinear optical crystal comprises a lithium niobate (LiNbO₃).

28. The method according to claim 19, wherein the nonlinear optical crystal comprises a gallium phosphide (GaP).

29. A method for generating the coherent multiple-stage optical rectification terahertz wave, comprising:
providing an ultrafast laser pulse, the ultrafast laser pulse been introduced to a first beam splitter and passing through a first nonlinear optical crystal via a first reflective mirror to generate a first broadband terahertz wave;
providing an ultrafast laser pulse, the ultrafast laser pulse been introduced to the first beam splitter and passing through a second nonlinear optical crystal via a second reflective mirror to generate a second broadband terahertz wave; and
superposing the first broadband terahertz wave and the second broadband terahertz wave by adjusting a time delay between the first broadband terahertz wave and the second broadband terahertz wave, so that both terahertz waves is superposed totally in a time domain in order to form the coherent multiple-stage optical rectification terahertz wave.

30. The method according to claim 29, wherein the ultrafast laser source comprises the ultrafast laser source being associated with a terahertz time domain spectroscopy (THz-TDS) to provide the THz wave.

31. The method according to claim 29, wherein the terahertz time domain spectroscopy comprises a second-order nonlinear process to produce and control the laser source.

32. The method according to claim 29, wherein the terahertz time domain spectroscopy comprises a third-order nonlinear process to produce and control the laser source.

33. The method according to claim 32, wherein the third-order nonlinear process comprises a high excitation plasma for producing the laser source.

34. The method according to claim 29, wherein the nonlinear optical crystal comprises a gallium selenide (GaSe).

35. The method according to claim 29, wherein the nonlinear optical crystal comprises a zinc telluride (ZnTe).

36. The method according to claim 29, wherein the nonlinear optical crystal comprises a lithium niobate (LiNbO₃).

37. The method according to claim 29, wherein the nonlinear optical crystal comprises a gallium phosphide (GaP).
